(19) United States
(12) Patent Application Publication
(10) Pub. No.: US 2006/0254796 A1
(43) Pub. Date: Nov. 16, 2006

(54) STORAGE CABINET STRUCTURE

(75) Inventor: Hsin-Yueh Chen, Pei Tou Hsiang (TW)

Correspondence Address: EGBERT LAW OFFICES, 412 MAIN STREET, 7TH FLOOR, HOUSTON, TX, 77002, US

(73) Assignee: I JANG INDUSTRIAL Co., Ltd., Pei Tou Hsiang (TW)

(21) Appl. No.: 11/299,632

(22) Filed: Dec. 13, 2005

(30) Foreign Application Priority Data
May 31, 2005 (TW) 094208994

(51) Int. Cl. H02G 3/08

(52) U.S. Cl. 174/50

(57) ABSTRACT

The storage cabinet structure includes a ␣-shaped bent edge formed where the right and left sides of the back board connect to the side boards, and positioning holes are placed on the front sides of the ␣-shaped bent edge from top to bottom; a vertical protruding strip placed on the inner wall on the front side of the side boards; and the shelf support of the supporting rack used to assemble the positioning holes and the back board for supporting the shelf. A frame of the bottom board can be placed on the top and bottom end of the side boards and back board, and its corresponding inner side is pushed against the concave edge to make the top and bottom ends of the top and bottom board and side boards. The storage cabinet that is easy to assemble, and has stronger structure is provided.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a structure of a storage cabinet, and more particularly to an invention that has all side boards assembled and a new structure of an S-shaped pivot on the door of the storage cabinet.

### BACKGROUND OF THE INVENTION

The assembled storage cabinet has the advantage of easy to dissemble and move; it is very popular among the consumers. Regardless of the storage cabinet that is made of wooden material or metal on the market today, there are many styles and structures for consumers to choose. As for the storage cabinet, the most common structure is still the structure that is assembled with frames. As for the conventional welded storage cabinets that have all metal boards and doors, these cabinets are almost no longer in existence because the side boards of the conventional structure of this type of metal storage cabinet usually are welded, when the user desires to use the assembled structure. Because of the challenge of the technical difficulty to make the connecting points durable, it can hardly provide the users with a practical and durable product.

Moreover, the pivot of the regular door of the storage cabinet usually has some hardware components, such as a butterfly type of button, for pivot; except, this type of hardware component must be screwed onto the storage cabinet, and it is not usually a problem for the wooden material. However, as for metal material, because of the screw holes needed to be put on the storage cabinet and its door, the cost will increase; and as for the popular DIY storage cabinet today, the structure of the button with screw may also be time consuming.

Thus, to overcome the aforementioned problems of the prior art, it would be an advancement if the art to provide an improved structure that can significantly improve the efficacy.

To this end, the inventor has provided the present invention of practicability after deliberate design and evaluation based on years of experience in the production, development and design of related products.

### BRIEF SUMMARY OF THE INVENTION

The improved facts of the present invention follow.

1. The present invention using the structure features a u-shaped bent edge and r-shaped bent edge shaped by both sides of the back board and left/right side board, and by so doing provides the secure connection between the back board and the side board. Meanwhile, it shapes a perspective space for the inserting part of the shelf support of the supporting rack to go through the positioning hole and shapes the boring hole for the bolt to go through. By this new structure to make up for the insufficient part of the current storage structure, the users are provided with a structure of a storage cabinet that is easy to assemble and secure, and further to meet the diversified demand of the consumers.

2. The present invention takes the positioning part of the S-shaped pivot and makes it into a S-shaped hole, so that when assembling the S-shaped pivot, its bar can be snapped into the vertical snap of the S-shaped hole through curvy path. The invention improves the issues of the conventional structure mentioned in the “Description of Related Art” to make the assembling more convenient and more effective without using other hand tools to achieve the practicability and advantages.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows the assembled perspective view of the present invention.

FIG. 2 shows the exploded perspective view of the present invention.

FIG. 3 shows an enlarged perspective view of the partial component of FIG. 2.

FIG. 4 shows another enlarged perspective view of the partial component of FIG. 2.

FIG. 5 shows the vertical sectional view of the connection between the back board and side boards by bolts.

FIG. 6 shows the horizontal sectional view of the connection between the back board and side boards of the present invention.

FIG. 7 shows the exploded perspective view of the components of the shelf of the present invention.

FIG. 8 shows the vertical sectional view of the components of the shelf of the present invention.

FIG. 9 shows the horizontal sectional view of the components of the shelf of the present invention.

FIG. 10 shows horizontal sectional view of the front side of the side board that can form the door stopper.

FIG. 11 shows the exploded perspective view of the S-shaped pivot and door of the present invention.

FIG. 12 shows one perspective view of the steps of assembling of the S-shaped pivot of the present invention.

FIG. 13 shows one perspective view of the steps of assembling of the S-shaped pivot of the present invention.

FIG. 14 shows an upper perspective view of the entire appearance of the storage cabinet of the present invention.

FIG. 15 shows the plan elevation view of the S-shaped pivot that is placed on the door.

FIG. 16 shows the detailed exploded perspective view of another embodiment of the top board of the present invention.

FIG. 17 shows most parts of the exploded perspective view of another embodiment of the top board of the present invention.

FIG. 18 shows the perspective view of another embodiment of the assembling of the top board of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

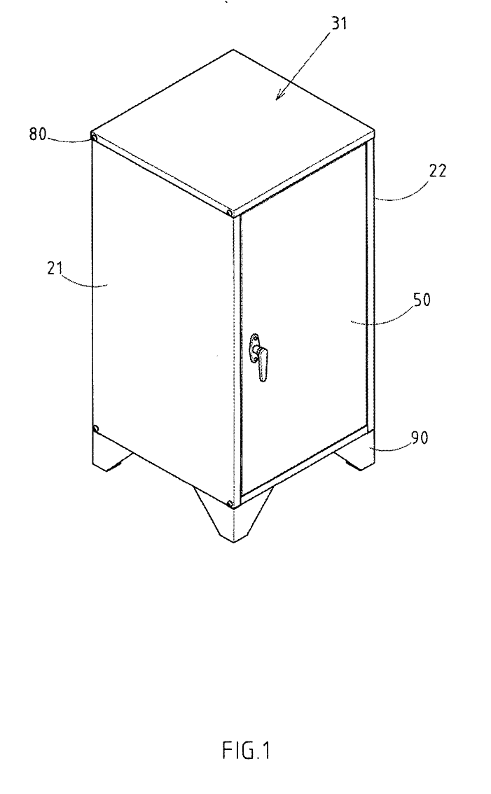

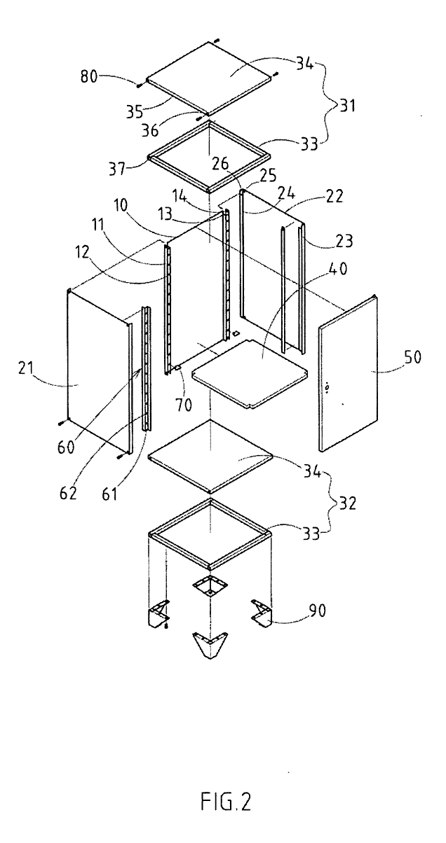

As shown in FIGS. 1-2, there is a preferred embodiment of the improved structure of a storage cabinet.

Its large body consists of a back board 10, a left side board 21, a right side board 22, a top board 31, a bottom board 32, a shelf 40 and a door 50, and all boards in the present embodiment are metal. Among them, the back board 10 is sealed to the back of the left/right side boards 21 22; and the door 50 is placed between the front sides of the left/right side board 21 22. The top board and bottom board 31 32 are to be placed on the top and bottom end of the left/right side boards 21 22 and the back board 10. The shelf 40 is to be placed in the internal space shaped by the back board 10, left/right side board 21 22.

A ␣-shaped bent edge 11 is formed where the right and left sides of the back board 10 connect to the left/right side boards 21 22, and positioning holes 12 are placed on the front sides of the ␣-shaped bent edge 11 from top to bottom. At the bottom of the internal side of the ␣-shaped bent edge 11 having a concave edge 13, the bottom end of the external side corresponding to the right and left sides of the ␣-shaped bent edge 11 has boring holes 14. The front and back sides of the left/right side board 21 22 has a [symbol] -shaped bent edge 23 24 that extends internally from one side, and among them, the [symbol] -shape bent edge 11 of the back side corresponds to the ␣-shape bent edge 11 of the back board 10. The through holes 25 are placed on the front and back corners on the top and bottom ends of the left/right side board 21 22, and among the through holes 25 on the back corner corresponds to the boring hole 14 of the ␣-shaped bent edge of the back board 10. On the top end, the [symbol] -shaped edge has the same concave edge 26 that lines up with the concave edge 13 on the back board 10. A vertical protruding strip 60 is placed on the inner wall on the front side of the left/right side board 21 22, and the vertical protruding strip has an internal convex 61 that corresponds to the front side wall of the ␣-shaped bent edge 11 on the left and right side of the back board 10 and is shaped as the positioning hole 62 that corresponds to it.

The shelf support 70 of the supporting rack is used to assemble the positioning holes 12 62 on the back board 10 and vertical protruding strip 60 on a left/right side board 21 22 for supporting the shelf, by using the inserting part 71 through the positioning hole 12 62 to form a stopper 72 that has limiting function and a supporting part 73 for the shelf 40.

The top and bottom board 31 32 comprises a frame 33 and a cover board 34, and the frame 33 can be assembled on the top and bottom end of left/right side board 21 22 and back board 10. Its internal sides are pushed against the concave edge, which makes the top and bottom sides of the frame of the bottom board even with the top and bottom sides of the left/right board and the back board, and all four sides of the cover board 34 have folded edge 35. The folded edge 35 of the cover board 34 on the top board 31 is folded on the external side on the top end of the left/right side boards 21 22 and back board 10 (as shown in FIG. 5), and each corner of the folded edge and frame has through hole and screw holes, which corresponding to the boring hole on the back board and through hole of the left/right side board, can be secured by bolts. The bolts connects the top and bottom board, left/right side board and back board; and each corner of the folded edge 35 and frame 33 has through hole 36 and screw holes 37, which correspond to the boring hole 14 on the back board 10 and through hole 25 of the left/right side board 21 22, and can be secured by bolts 80. The bolts connect the top and bottom board 31 32, left/right side board 21 22 and back board 10.

Among them, the shelf support 70 of the supporting rack can be made of metal, and its external end makes a flat surface to form its supporting part 73. Its internal end makes a oblique surface to forms its inserting part 71. Both sides of the supporting part 73 has a curvy board that faces down and forms a triangle space with the inserting part 71 to form its stopper 72, so that the back board 10 and the positioning holes 12 62 of the left/right side board 21 22 become horizontal rectangle holes and correspond with the inserting part 71 mentioned above.

Among them, the vertical protruding strip 61 on the front internal wall of the left/right board 21 22 can be a metal plate that is made independently and welded into a_shaped plate (see FIGS. 4 and 9).

Among them, the bottom board 32 has floor stands 90 on all corners of the frames 33.

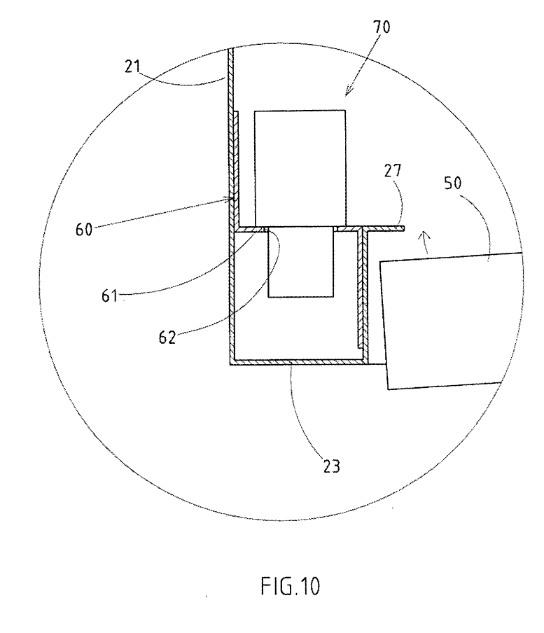

Among them, as shown in FIG. 10, the [symbol] -shaped bent edge 23 on the front sides of one side board 21 can be extended to from a door stopper 27 for the door to push against when it is closed.

According to the structure, components mentioned above, the steps to assemble the storage cabinet of the present invention follow.

First, the [symbol] -shaped bent edge 24 on the back side of the left/right side board 21 22 is connected with the ␣-shaped bent edge 11 of the back board 10, and connected with the top/bottom board 31 32 to the top and bottom end of the left/right side board 21 22 and the back board 10, so that their internal sides can be pushed against the concave edge 13 26 to make the top and bottom ends of the frame 33 of the top/bottom board even with the top and bottom ends of the left/right side board 21 22. Followed by screwing the bolts 80 on all corners, and after the bolts 80 are secured, the structure of the external frame of the storage cabinet is complete. As for assembling the internal shelf 40, the user may assemble the storage cabinet according to the height and volume of the shelf 40 to distribute the position of the supporting rack 70, and then position all shelves 40. Moreover, the assembling of the door 50 can be assembled according to the different structures (such as back button, turning knob) of the connecting part. Any of the assembling of the storage cabinet may be completed.

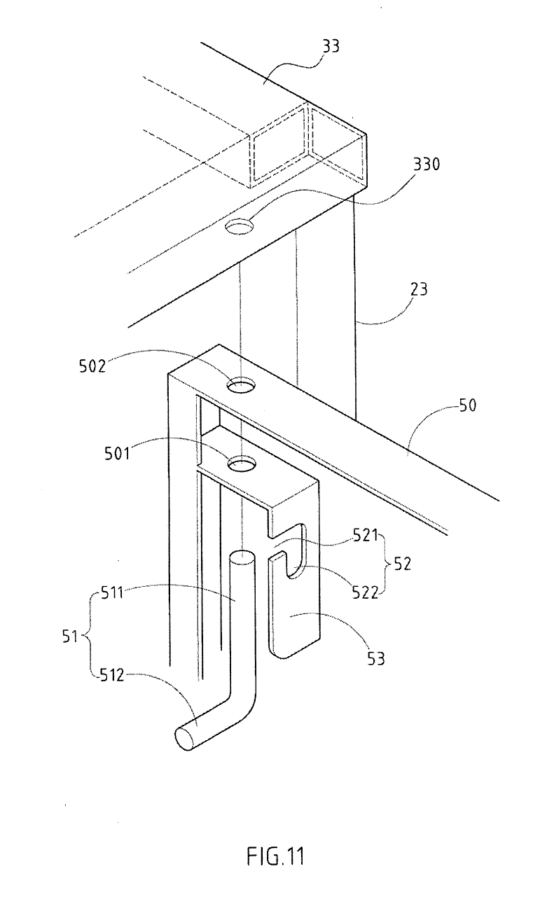

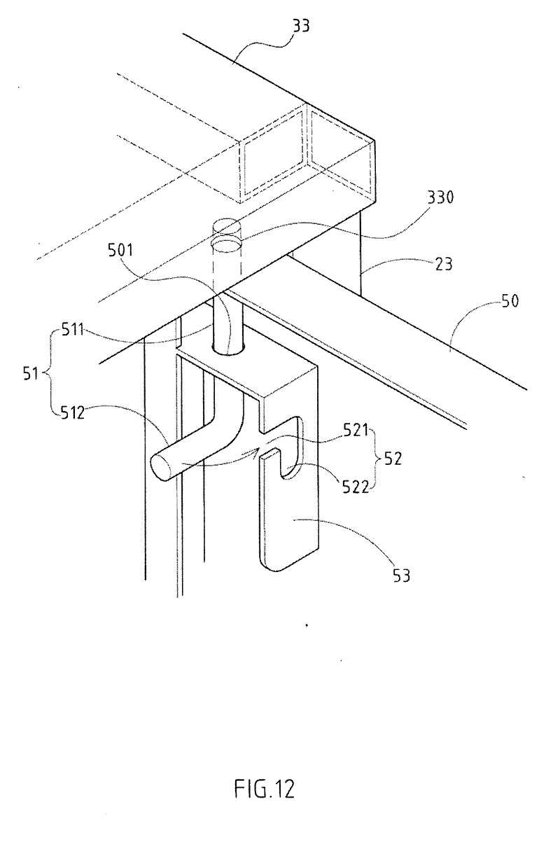

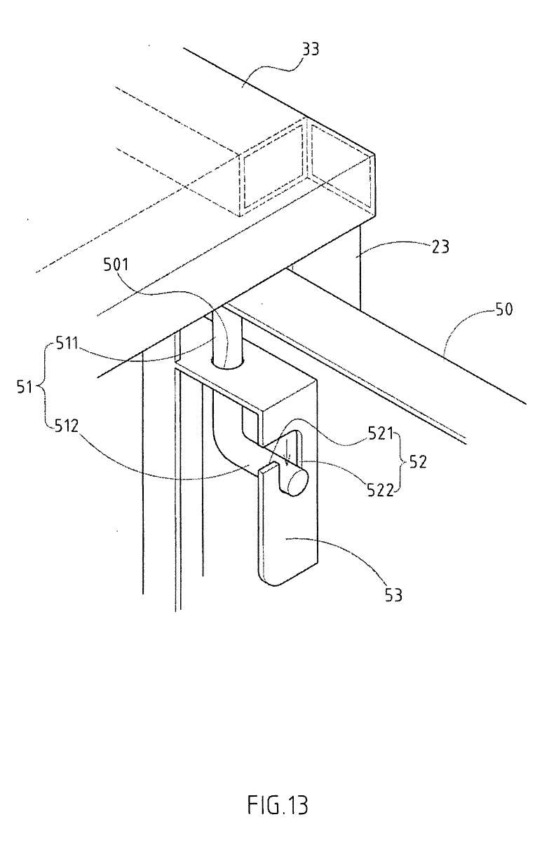

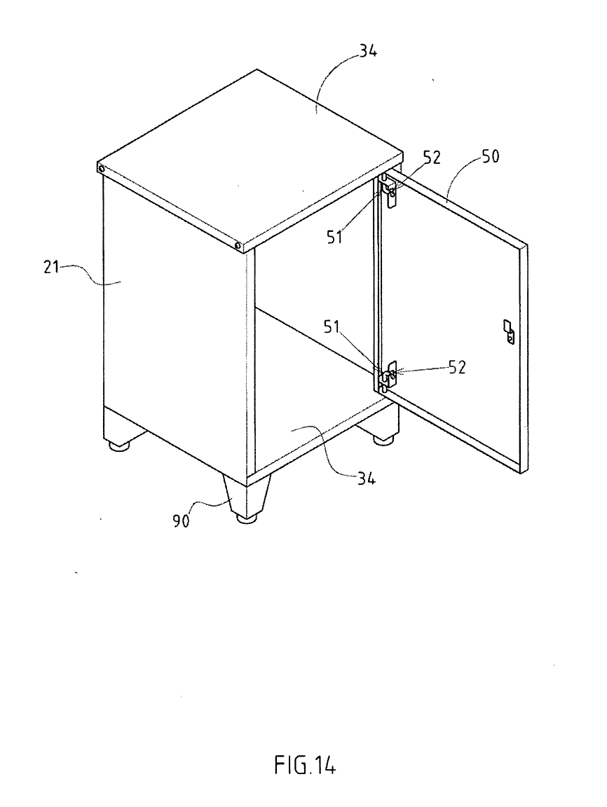

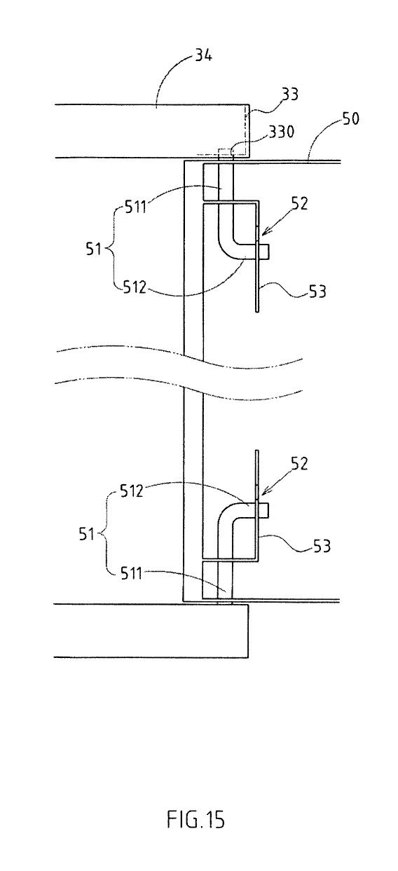

Moreover, as shown in FIGS. 11 and 12, the connecting part of the top and bottom end of the door of the storage cabinet has the S-shaped pivot 51, and the S-shaped pivot can be positioned by the positioning part of the connecting part mentioned above. The end of the supporting rod 511 of the S-shaped pivot 51 can be inserted to a pivot hole 330 of the top frame 33 (or the bottom frame) of the storage cabinet, so that the door 50 can use the pivot hole 33 as the supporting point to open and close. Among them, the supporting rod 511 of the S-shaped pivot 51 goes through two through holes 501 502 on the connecting part of the door 50 and form an axle. Among them, the positioning part mentioned above is a S-shaped hole 52, and the S-shaped hole includes a horizontal guide 521 and a vertical snap 522. So that the bar 512 of the S-shaped pivot 51 mentioned above can be snapped to the vertical snap 522 after lowering the horizontal guide 521 of the S-shaped hole 52, the S-shaped pivot 51 reach a position that would not turn and would not fall as well.

Among them, the S-shaped hole 52 can be placed on the door 50, and a plate 53 can be placed on the connecting part, and the bar 512 of the S-shaped pivot 51 can correspond vertically.

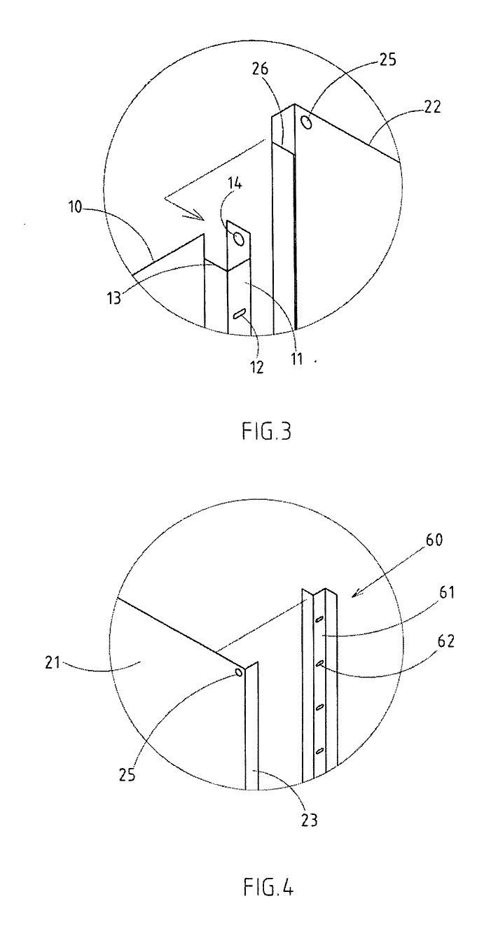

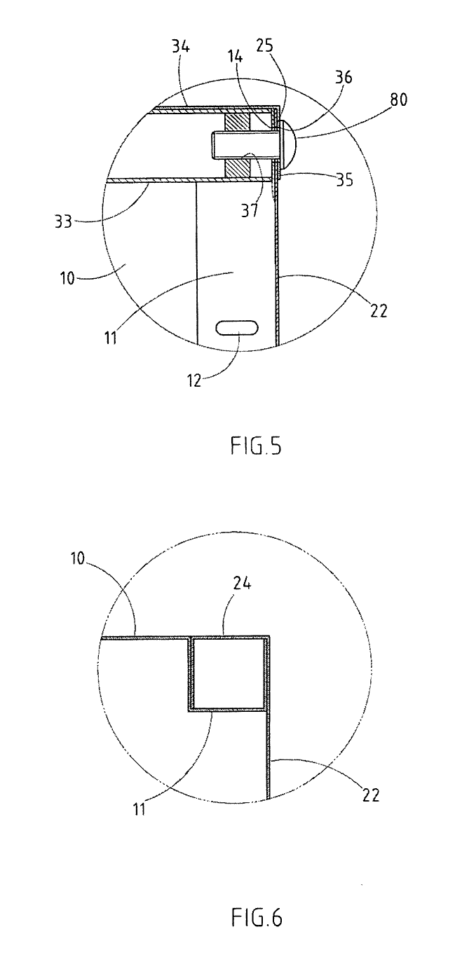

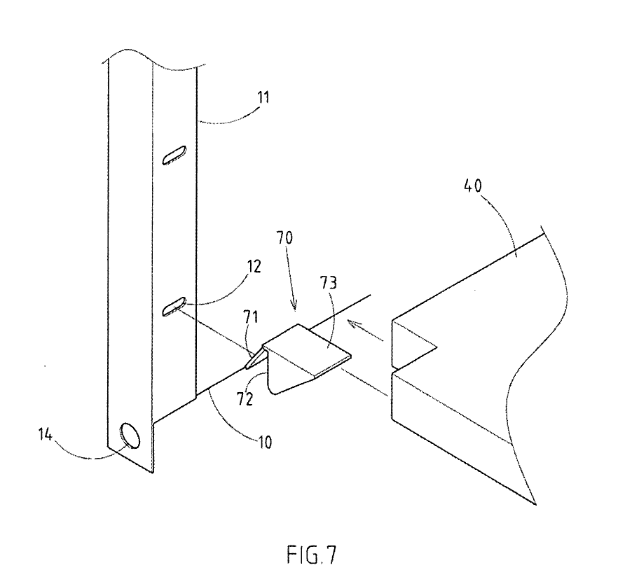

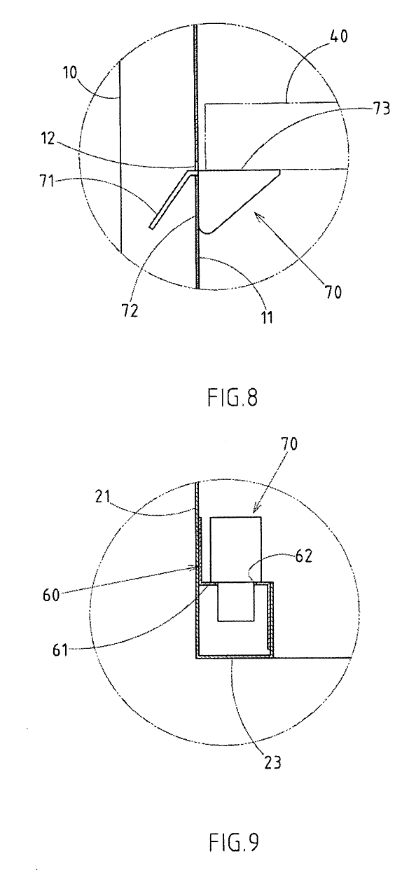

By the structure and invention mentioned above, when the S-shaped pivot 51 mentioned above is assembled, as shown in FIG. 11, so that its supporting rod 512 goes through the door 50 from bottom to top by two through holes 501 502, and a pivot hole 330 is inserted into on the top frame 33 of the storage cabinet, as shown in FIG. 2. So that the bar of the S-shaped pivot 51 swings horizontally toward one side and makes the horizontal guide 521 of the S-shaped hole 52 snapped into the vertical snap 522 of the S-shaped hole 52 (as shown in FIG. 3). By so doing, it makes the S-shaped pivot 51 be positioned to the state that it would not turn and would not fall as well. On the other hand, when the user desires to take off the S-shaped pivot 51, lift its bar 512 off the vertical snap 522 and turn it outward by horizontal guide 521, so that the entire S-shaped pivot 51 can be taken off the door 50 and the storage cabinet. Therefore, regardless of assembling or disassembling, the S-shaped pivot 51 is quite easy and fast without help from any tool.

In addition, the S-shaped pivot 51 goes down naturally by gravity after it is assembled, so that its bar 512 can be kept snapping in the vertical snap 522 of the S-shaped hole 52, and the opening and closing of the door 50 are horizontal, therefore, it would not affect the position of the S-shaped pivot 51.

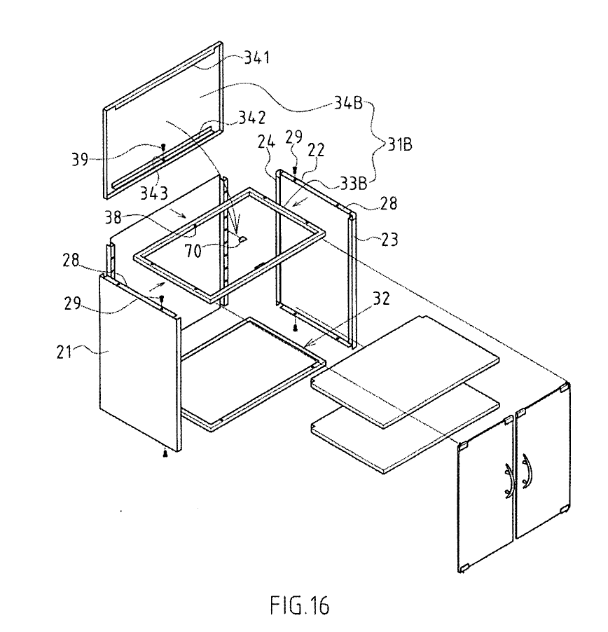

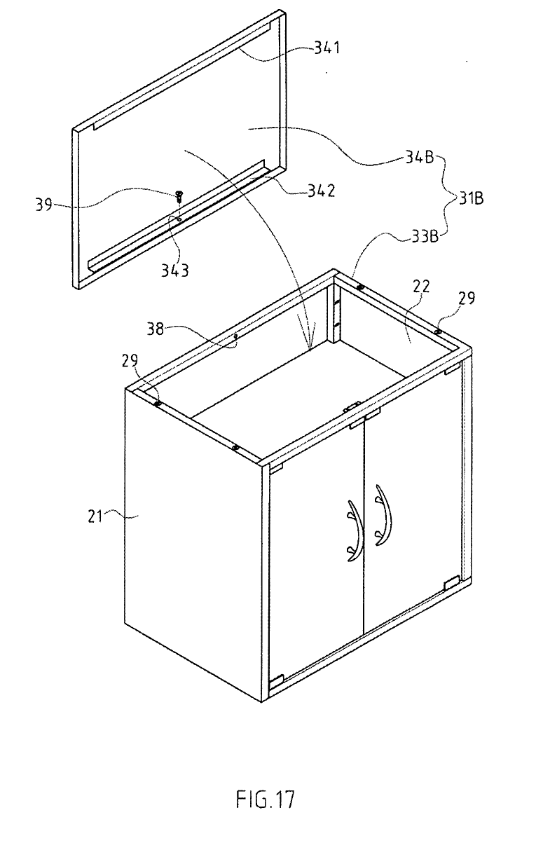

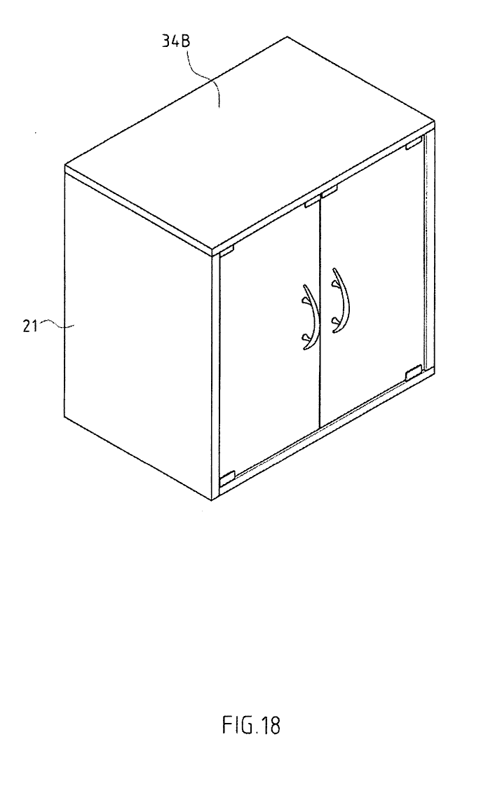

As shown in FIGS. 16, 17, which is another embodiment of the assembling of the top board of the present invention, the frame 33B of the top board 31 B is to be placed on the bent surface 28 on the top end of the left/right side board 21 22 and be positioned through the bolt 29 that is assembled vertically. The horizontal screw hole 38 is placed at the back of the frame 33B, so that a buffer edge 341 that is set on the front side of the bottom of the cover board 34B can be snapped into the bottom of the frame 33B on the front side, and the bottom of the cover board 34B has a connecting board 342 can be placed closed to the back side of the frame 33B. The connecting board 342 has a boring hole 343 that corresponds to the screw hole 38 that are on the back sides of the frame 33B, and is positioned by the bolt 39 secured horizontally, and by so doing to assemble the cover board 34B and the frame 33B. After the entire top board 31B is assembled, it shows a beautiful appearance without any bolts on the outside (as shown in FIG. 18).

1. A storage cabinet structure comprised of a back board, left and right side boards, a top board and a bottom board, a shelf and door, said back board being sealed to a back of the left and right side boards, said door being placed between front sides of the left and right side boards, the top board and bottom board being placed on a top and bottom end of the left and right side boards and the back board, said shelf being placed in an internal space shaped by the back board, and the left and right side boards, a S-shaped pivot being placed on a connection of the top and bottom end of the door of the storage cabinet and being positioned on said connection, said storage cabinet structure comprising:
a ␣-shaped bent edge being formed where right and left sides of the back board connect to the left and right side boards; and having positioning holes are placed on front sides of the ␣-shaped bent edge from top to bottom, at a bottom of an internal side thereof, said ␣-shaped bent edge having a concave edge, at a bottom end of an external side thereof corresponding to the right and left sides thereof, said ␣-shaped bent edge having boring holes, front and back sides of the left and right side boards having [symbol] -shaped bent edges extending internally from one side, each of said [symbol] -shape bent edges of the back side corresponding to said ␣-shape bent edge, through holes being placed on front and back corners on top and bottom ends of the left and right side boards, among the through holes on the front and back corners, each through hole corresponding to one of the boring holes of the u-shaped bent edge of the back board, a vertical protruding strip being placed on an inner wall on a front side of the left and right side boards, said vertical protruding strip having an internal convex shape corresponding to a front side wall of said ␣-shaped bent edge on the left and right side boards of the back board and shaped corresponding to one of the positioning holes; and
a shelf support of a supporting rack used to assemble the positioning holes on the back board and the vertical protruding strip left and right side board, supporting the shelf, forming a stopper by using the inserting part through the positioning hole said stopper having a limiting function and a supporting part for said shelf;
wherein top and bottom boards comprise a frame and a cover board, said frame being assembled on a top and bottom end of left and right side boards and the back board, said frame having internal sides being pushed against said concave edge, making top and bottom sides of said fame even with top and bottom sides of the left and right boards and the back board, all four sides of said cover board having folded edges, each folded edge of said cover board on a top board being folded on an external side on the top end of the left and right side boards and the back board, each of said corners of the folded edge and the frame having a through hole and a screw hole, corresponding to one of the boring holes on the back board and one of the through holes of the left and right side boards, and can be secured by bolts, respectively, connecting top and bottom boards, left and right side boards and back board; and
wherein an end of said supporting rod of said S-shaped pivot inserts into a pivot hole of a top frame, a said door using a said pivot hole as a supporting point to open and close, said supporting rod of said S-shaped pivot passing through said through holes on a connecting part of said door and forming an axle, said S-shaped pivot having a bar positioned through said positioning part of said door, said positioning part being comprised of an S-shaped hole, said S-shaped hole comprising a horizontal guide and a vertical snap, said bar of said S-shaped pivot is being snapped to a vertical snap after lowering the horizontal guide of said S-shaped hole, making said S-shaped pivot reach a position.

2. The structure defined in claim 1, wherein said shelf support of said supporting rack is comprised of metal, an external end of said shelf support making a flat surface to form said supporting part, an internal end of said shelf support making an oblique surface forming an inserting part, both sides of said supporting part having a curvy board facing down and forming a stopper, the back board corresponding to one of the positioning holes of the left and right side boards making a rectangle hole and said inserting part.

3. The structure defined in claim 1, wherein said vertical protruding strip on a front internal wall of the left and right boards is comprised of a metal plate formed independently and welded into a [symbol]
shaped plate.

4. The structure defined in claim 1, wherein the bottom board has floor stands on all corners of frames thereof.

5. The structure defined in claim 1, wherein the n-shaped bent edge on each front side of the left and right side boards is extendable, forming a door stopper.

6. The structure defined in claim 1, wherein the S-shaped hole is placed on a plate on a connection of said door, a bar of said plate and the S-shaped pivot being placed vertically.
